(19) United States
(12) Patent Application Publication
(10) Pub. No.: US 2020/0325054 A1
(43) Pub. Date: Oct. 15, 2020

(54) SYSTEMS, APPARATUSES, AND METHODS OF DEWATERING SOLID/LIQUID MIXTURES

(71) Applicant: Keith M. Hitzke, Germantown, WI (US)

(72) Inventor: Keith M. Hitzke, Germantown, WI (US)

(21) Appl. No.: 16/843,161

(22) Filed: Apr. 8, 2020

Related U.S. Application Data
(60) Provisional application No. 62/834,106, filed on Apr. 15, 2019.

(51) Int. Cl. C02F 11/128; B09B 1/00

(52) U.S. Cl. CPC C02F 11/128; B09B 1/00

(57) ABSTRACT

A system for dewatering a solid/liquid mixture is provided. The system is configured to separate the solids and liquid from the solid/liquid mixture. A method of dewatering is also provided. A mobile filtration system is provided. A system for separating a solid/liquid mixture is provided and includes a dump basin and a filter container in fluid communication with the dump basin. The dump basin includes a floor upon which an earthmoving implement may drive and upon which a solid/liquid mixture is dumped. The floor may define a plurality of apertures therein through which liquid from the solid/liquid mixture passes and through which the solid does not pass. The liquid passing through, the floor flows into the filter container. The filter container may include a weir plate. Methods of operation and assembly are further provided.

### RELATED APPLICATIONS

This application claims the benefit of co-pending provisional application Ser. No. 62/634,106 filed 15 Apr. 2019.

### FIELD OF THE INVENTION

The present disclosure generally relates to separating liquid from solid in solid/liquid mixtures and, more particularly, to dewatering solid/liquid mixtures using systems, apparatuses, and methods, and more specifically to solid/liquid separation systems, apparatuses and methods allowing for positioning of a truck on the systems and apparatuses, removal of solid waste from a lower cavity of the system using a mechanized earthmoving implement, and aperture orientations allowing for separation of solids and liquids.

### BACKGROUND OF THE INVENTION

Solid/liquid mixtures originate in a variety of industries and applications, and disposal thereof is becoming more difficult due to environmental concerns. In some jurisdictions, landfills accept dumping of certain solid/liquid mixtures. In other jurisdictions, dumping of any solid/liquid mixtures is prohibited. Solid/liquid mixtures in landfills may be referred to solidification waste, which may present an unstable slope to the landfill, instability in the slope of a landfill may result in sliding or other issues with the landfill. Thus, a need exists to address solid/liquid mixtures in jurisdictions that do not accept, dumping of solid/liquid mixtures.

One example of an application generating solid/liquid mixtures is hydro-excavation. Hydro-excavation is a popular process of removing or moving soil with pressurized liquid (e.g., water). A vacuum is used to transfer the solid/liquid to a storage tank. Hydro-excavation is less destructive and more accurate than industrial digging/excavating equipment. Many types of hydro-excavation earthmoving implements exist and such earthmoving implements include a liquid tank, a storage tank for the solid/liquid mixture, a source of pressurizing the liquid, a source for applying vacuum, among other things. As indicated above, some jurisdictions allow dumping of the solid/liquid mixture resulting from hydro-excavation and some jurisdictions do not allow dumping of such mixtures. Furthermore, in jurisdictions allowing dumping, the landfills accepting dumping may charge additional fees for dumping, thereby increasing the cost of hydro-evacuation. Additionally, a hydro-evacuation earthmoving implement may be required to travel great distances to the landfills accepting dumping of the solid/liquid mixtures, thereby increasing the cost of hydro-evacuation and decreasing operation time of the hydro-evacuation earthmoving implement. Thus, a need exists to address these deficiencies.

### SUMMARY OF THE INVENTION

The present disclosure generally relates to separating liquid from solid in solid/liquid mixtures and, more particularly, to dewatering solid/liquid mixtures using systems, apparatuses, and methods, and more specifically to solid/liquid separation systems, apparatuses and methods allowing for positioning of a truck on the systems and apparatuses, removal of solid waste from a lower cavity of the system using a mechanized earthmoving implement, and aperture orientations allowing for separation of solids and liquids.

The present disclosure may be defined by the following claims, and nothing in this section should be taken as a limitation on those claims.

In one aspect, a system for dewatering a solid/liquid mixture is provided.

In one aspect, a system for separating a solid/liquid mixture is provided.

In one aspect, a method of dewatering a solid/liquid mixture is provided.

In one aspect, a method of separating a solid/liquid mixture is provided.

In one aspect, a mobile filtration system is provided.

In one aspect, a system for separating a solid/liquid mixture is provided and includes a dump basin and a filter container in fluid communication with the dump basin. The dump basin includes a floor upon which an earthmoving implement may drive and upon which a solid/liquid mixture is dumped.

In one aspect, a system for separating a solid/liquid mixture is provided and includes a dump basin and a filter container in fluid communication with the dump basin. The dump basin includes a floor upon which an earthmoving implement may drive and upon which a solid/liquid mixture is dumped. The floor defines a plurality of apertures therein through which liquid from the solid/liquid mixture passes and through which the solid does not pass. The liquid passing through the floor flows into the filter container. The filter container includes a weir plate.

The invention is to a system for dewatering a solid/liquid mixture, the system comprises: a dump basin defined by walls and having a front side, wherein an earthmoving implement drives through the front side into the dump basin; the dump basin defining a cavity; the dump basin including a floor over the cavity; the floor comprising at least one structural truss extending into the cavity; and the floor comprising by at least one aperture; wherein the solid/liquid mixture is filtered through the at least one aperture.

The invention further provides for the dump basin comprises a first basin removably coupled to a second basin along interior walls; at least one earthmoving implement entry ramp is in close proximity to said front side; a plurality of apertures; the floor having an area with a reduced number of apertures for receiving the solid/liquid mixture; the aperture is positioned at an acute angle with respect to the front side; the aperture is positioned opposite a second aperture providing for a chevron pattern; the aperture is positioned at least one of parallel to the front side and orthogonal to the front side; the floor comprises four floor sections; at least one floor section having at least one structural, truss extending from the floor section into the cavity; the floor detachably positioned within the dump basin; the floor provides for at least one first lift mechanism for detachable positioning; the cavity having at least one drain opposite the front side, wherein the solid/liquid mixture advances in a direction of the drain; a filter container in hydraulically coupled with the at least one drain, wherein the solid/liquid mixture is further separated in the filter container; a beveled edge within the cavity, wherein solid/liquid mixture is advanced in the direction of the drain; and at least one barrier removably positioned on at least one wall.

A method of operating a system for dewatering a solid/liquid mixture comprises; depositing a solid/liquid mixture onto a floor of a dump basin; filtering the solid/liquid mixture through apertures in the floor into a cavity of the dump basin; transporting an amount of the solid/liquid mixture in a direction of at least one dram; transporting the amount of solid/liquid mixture from the dram to a filter container; removing solids remaining on the floor using an earthmoving implement; and removing the solids within the cavity through use of at least one of a mechanical arm or the earthmoving implement driven ante the cavity. The method further comprises: driving an earthmoving implement onto the floor for removing the solids from the floor; and employing a rear side of the dump basin to remove the solids from the floor.

A method of assembling a system for dewatering a solid/liquid mixture comprises: positioning a first basin; positioning a second basin in contact with the first basin along interior walls of the first basin and the second basin; coupling the first basin to the second basin along the interior walls; positioning at least one floor section within at least one of the first basin and the second basin; hydraulically coupling at least one of the first basin and the second basin to the filter container; and installing at least one filter assembly into the filter container.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 is a side view of an example of the system for dewatering solid/liquid mixtures and one example of an earthmoving implement for providing solid/Liquid mixtures into the system.

FIG. 2 is a top view of the system of a dump basin of the system.

FIG. 3 is a front view of the dump basin of the system.

FIG. 4 is a rear view of the dump basin of the system.

FIG. 5 is a focused cross-sectional view of a center of the dump basin of the system, illustrating a contact between floors and interior walls of the dump basin.

FIG. 6 is a focused cross-sectional view of an exterior wall of the dump basin of the system, illustrating communication of the floor with the exterior wall.

FIG. 7 is an exploded view of the dump basin of the system.

FIG. 8 is a perspective view of the floor of a front portion of the dump basin of the system, illustrating a first embodiment of the aperture arrangement within the floor with the apertures at a first orientation.

FIG. 9 is a perspective view of the floor of a rear portion of the dump basin of the system, illustrating a second embodiment of the aperture arrangement within the floor with the apertures at a first orientation.

FIG. 10A is a perspective view of the floor of the dump basin of the system, illustrating a first embodiment of the aperture arrangement within the floor with the apertures at a second orientation.

FIG. 10B is a perspective view of the floor of the dump basin of the system, illustrating a first embodiment of the aperture arrangement within the floor with the apertures at a third orientation.

FIG. 11 is a side view of the floor of the dump basin of the system.

FIG. 12 is a perspective view of the dump basin of the system with the floors removed.

FIG. 13 is a top, view of the dump basin of the system with the floors removed.

FIG. 14 is a focused view of the dump basin of the system with the floors removed, illustrating a beveled edge.

FIG. 15 is a perspective view dump basin of the system with the floors removed, illustrating a removable guard.

FIG. 16 is a perspective of a filtration tank of the system, illustrating application of weir plates.

FIG. 17 is a perspective view of an alternative embodiment of a weir plate.

FIG. 18 is a focused view of the filtration tank of the system, illustrating inlets for access to the filtration tank.

FIG. 19 is a side view of the filtration tank of the system, illustrating an alternative orientation of weir plates within the filtration tank.

FIG. 20 is a flow chart for a method of assembling the system.

FIG. 21 is a flow chart for a method of disassembling the system.

FIG. 22 is a method of operation of the system, illustrating depositing of a solid/liquid mixture into the dump basin by the earthmoving implement for providing solid/liquid mixtures into the system.

FIG. 23 is the method of operation of the system, illustrating separation of solids and liquids in the dump basin.

FIG. 24 is the method of operation of the system, illustrating separation of solids and liquids in the dump-basin.

FIG. 25 is the method of operation of the system, illustrating removal of solids from the floor of the dump basin.

FIG. 26 is the method of operation of the system, illustrating removal of solids from a base of the dump basin.

FIG. 27 is a top view of an alternative embodiment of the system.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

Many types of solid/liquid mixtures 119 exist and are created in a variety of industries by a variety of applications. Such mixtures 119 ultimately need to be disposed of or treated prior to disposal. Disposal of such mixtures 119 is becoming more difficult since contamination is a major concern. Jurisdictions around the world vary in policy and procedure when it comes to disposal of solid/liquid mixtures 119. Such, policy depends on the type of solid/liquid mixture 119.

One example of an industry creating solid/liquid mixture 119 is hydro-evacuation. Hydro-evacuation utilizes pressurized liquid (typically water) and vacuum to excavate soil. Hydro-evacuation is less destructive and more accurate than industrial equipment. Hydro-evacuation is typically performed by a hydro-evacuation, earthmoving implement, such as a truck, including a liquid tank, a solid/liquid storage tank, a source of pressurizing the liquid, a source for applying vacuum, along with other equipment. The solid/liquid mixture created by this process may be referred to as hydro-vac waste, sediment sludge, viscous solid waste, wet sediment, slurry waste stream, among others.

Some jurisdictions include landfills accepting dumping of the solid/liquid mixture 119 created by the hydro-evacuation process, while other jurisdictions do not. The hydro-evacuation earthmoving implements are required to travel to the landfills accepting dumping of the solid/liquid mixture 119, which can consume large quantities of time and increase the downtime of the hydro-evacuation earthmoving implements, furthermore, landfills excepting such solid/liquid mixtures 119 often charge extra fees, thereby increasing the cost of the hydro-evacuation process.

With reference to FIGS. 1-3, one example of a system for separating solid and liquid in a solid/liquid mixture 119 is provided. The system 20 is capable of separating a variety of types of solid/liquid mixtures. For purposes of demonstrating principles of the system 20, the system 20 will be described with respect to separating solid and liquid in a solid/liquid mixture created by a hydro-excavation application. The system 20 is also mobile and easily transportable along traditional roads and highways via trailers coupled to trucks approved to transport, objects along such traditional roads and highways.

As illustrated in FIG. 1, the system 20 includes a dump basin 24 and a filter container 28. In one example, the dump basin 24 may be about 16-feet by about 28-feet. In another example, the dump basin 24 may be about 16-feet by about 30-feet. In a further example, the dump basin 24 may be about 16-feet by about 22-feet. It should be understood that dump basin 24 is capable of having a wide variety of shapes, sires, and configurations and all of such possibilities are intended to be within the spirit and scope of the present disclosure.

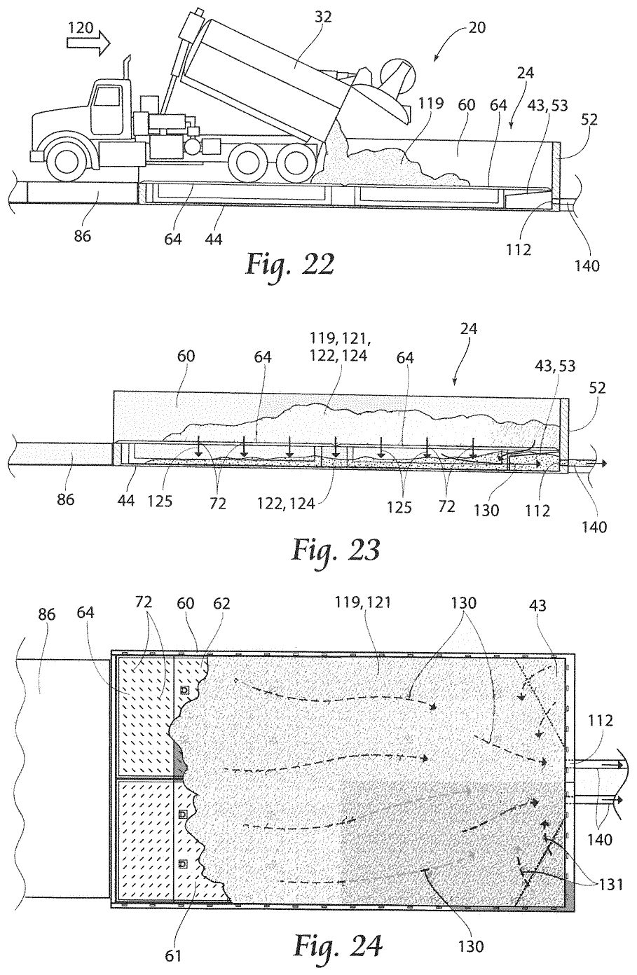

A hydro-evacuation earthmoving implement 32 (one example illustrated in FIGS. 1 and 22) is capable of backing onto the basin 24 and dumping the solid/liquid mixture 119 onto the dump basin 24, 120 reference FIG. 22.

As illustrated in FIG. 23, the dump basin 24 performs a first or initial separation or filtering of the solid and liquid from the solid/liquid mixture 119. Larger solids 121 remain on the dump basin 24, while the liquid and smaller solids 122, and finer solids 124 flow through the dump basin 24 and into the filter container 28, 123.

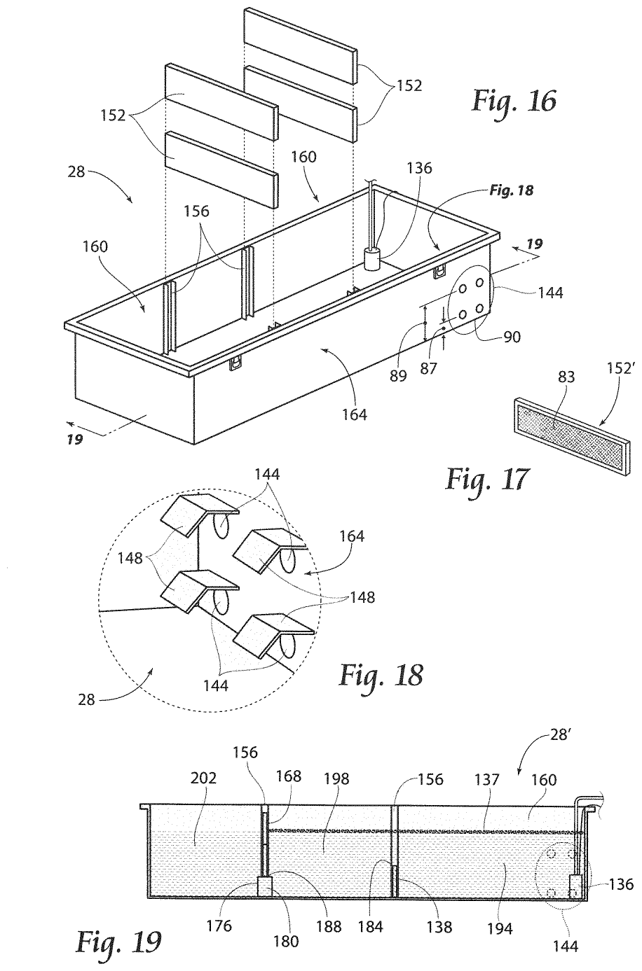

The filter container 28, illustrated in FIGS. 16-19, is configured to perform a further or second separation of solid from liquid by separating finer solids or sediment 124 from the liquid. In one example, the filter container 28 may be referred to as a sediment tank or sediment container. The finer solids 124 settle in the filter container 26 while the liquid rises. The liquid is then withdrawn from the filter container 28. The solids remaining on the dump basin 24 (119, 122) and the finer solids or sediment 124 in the filter container 28 may then be disposed of at landfills as any other solids may be disposed or recycled for other purposes. The system 20 of the present disclosure allows solids (121, 122, 124) present in a solid/liquid mixture 119 to be disposed of and may also eliminate any extra fee charged by a landfill to accept a solid/liquid mixture 119 since the liquid has been separated out from the solid.

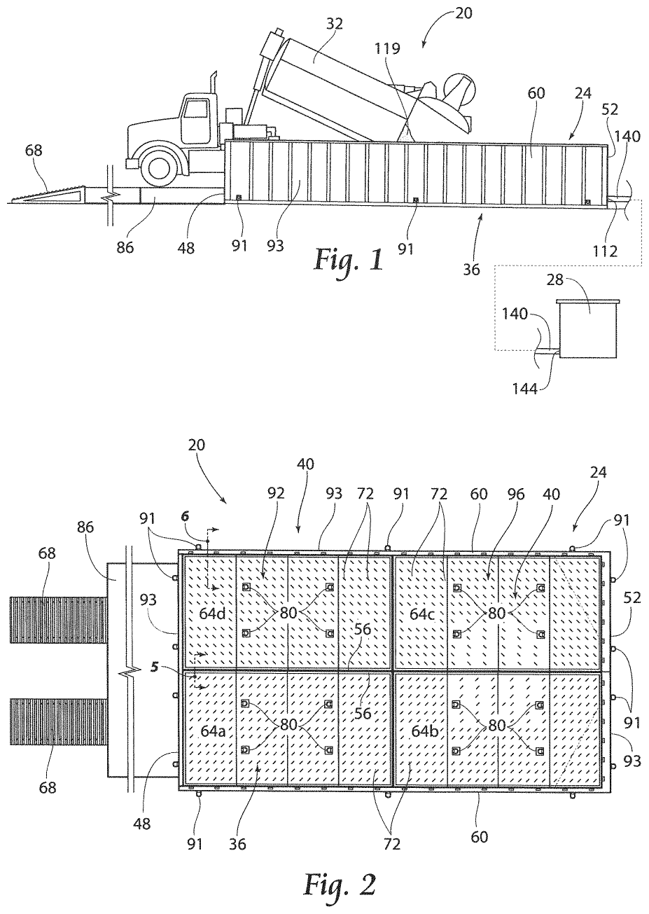

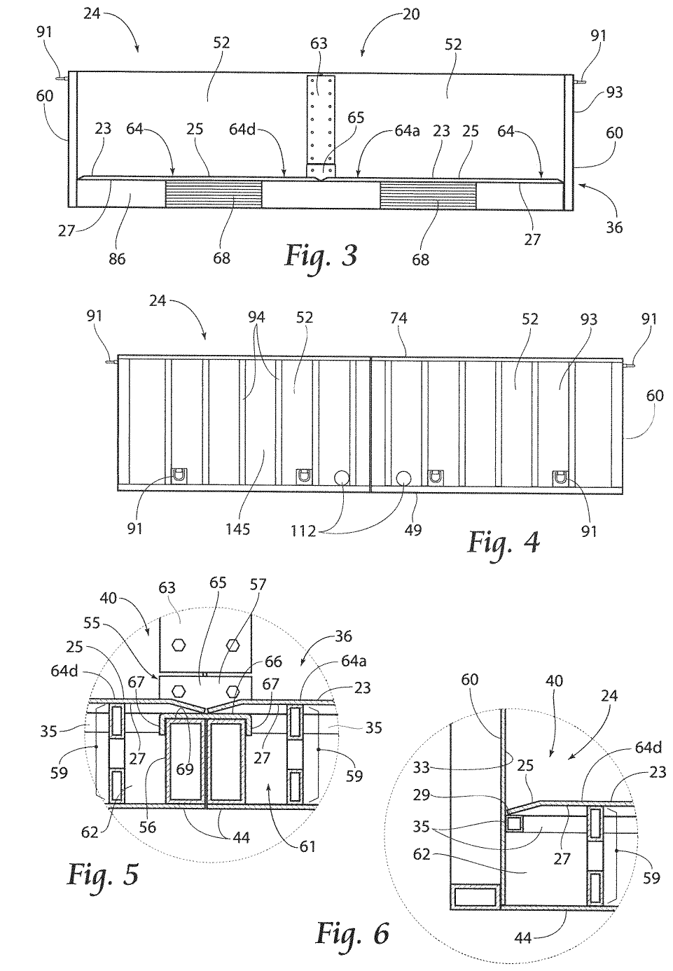

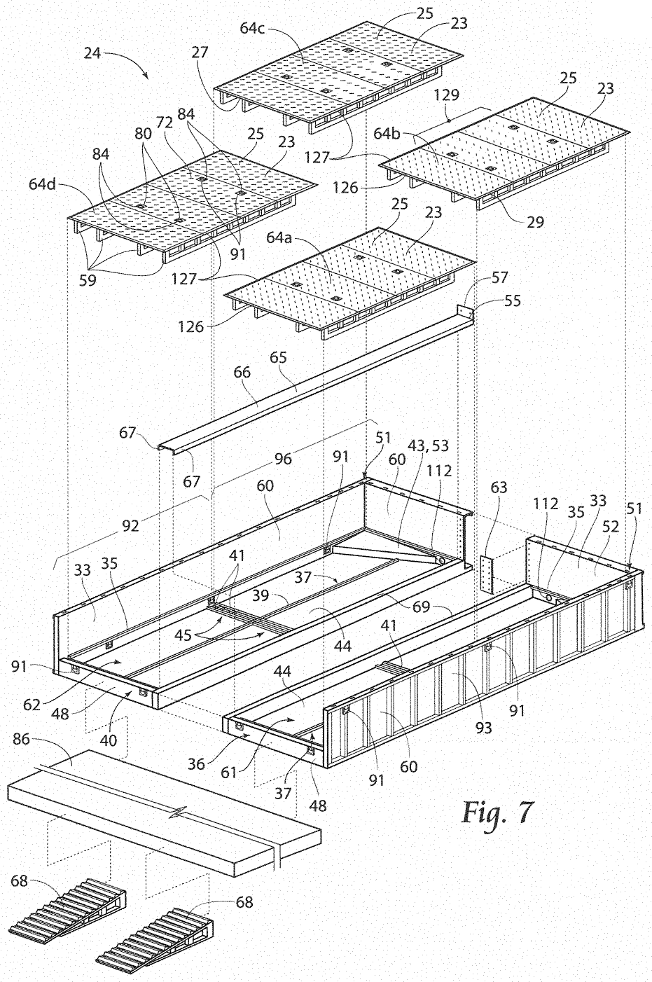

With continued reference to FIGS. 1-15 and 27, the dump basin 24 will be described in more detail. With particular reference to FIGS. 1 and 7, in one example, the dump basin 24 is comprised of a first basin 36 and a second basin 40. As illustrated in FIGS. 2, 3 and 7, each of the first basin 36 and the second basin 40 includes a base 44, a front wall 48, a rear wall 52, an interior wall 56, and an exterior wall 60 together respectively defining a first basin cavity 61 and a second basin cavity 62. As illustrated in FIGS. 7, 12, and 13, in one example, the first and second cavities 61, 62 are independent of each other and are not in fluid communication with each other such that liquid dumped into one cavity does not flow into the other cavity. The system 20 may include a plurality of coupling members to couple the first and second basins (36, 40) together. In one example, the system 20 includes a first coupling member 63 coupled to rear walls 62 of the first and second basins (36, 40). The combined rear walls 52 create a rear side 145 of the dump basin 24, reference FIG. 4. The first coupling member 63 may be coupled to the rear walls 52 in a variety of manners including, but not limited to, fastening, bonding, welding, adhering, or any other type of temporary, permanent, or semi-permanent coupling process. In the illustrated example, the first coupling member 63 is fastened to the rear walls 52 of the first and second basins (36, 40) as shown in FIGS. 3, 5 and 7. The first coupling member 63 not only secures the first and second basins (36, 40) together, but the first coupling member 63 also covers or blocks a gap that may be present between the rear walls 52 of the first and second basins (36, 40), thereby inhibiting liquid that may be dumped onto the dump basin 24 from flowing through the gap and off of the dump basin 24.

In one example, the system 20 includes a plurality of second coupling members 65 coupling the first and second basins (36, 40) together. With particular reference to FIGS. 5 and 7, the plurality of second coupling members 65 may be generally “C”-shaped members with each of the second coupling members 65 including a base 66 and two flanges 67 extending from the base 66. The base 66 of each of the second coupling members 65 rests upon top edges 69 of the interior walls 56 of the first and second basins (76, 40), one of the flanges 67 extends downward into the first basin 36, and the other of the flanges 67 extends into the second basin 40. The second coupling members 65 not only secure the first and second basins (36, 40) together, but the second coupling members 65 also block a gap that may be present between the adjacent interior walls 36 of the first and second basins (36, 40), thereby inhibiting liquid that may be dumped onto the dump basin 24 from flowing through the gap and off of the dump basin 24.

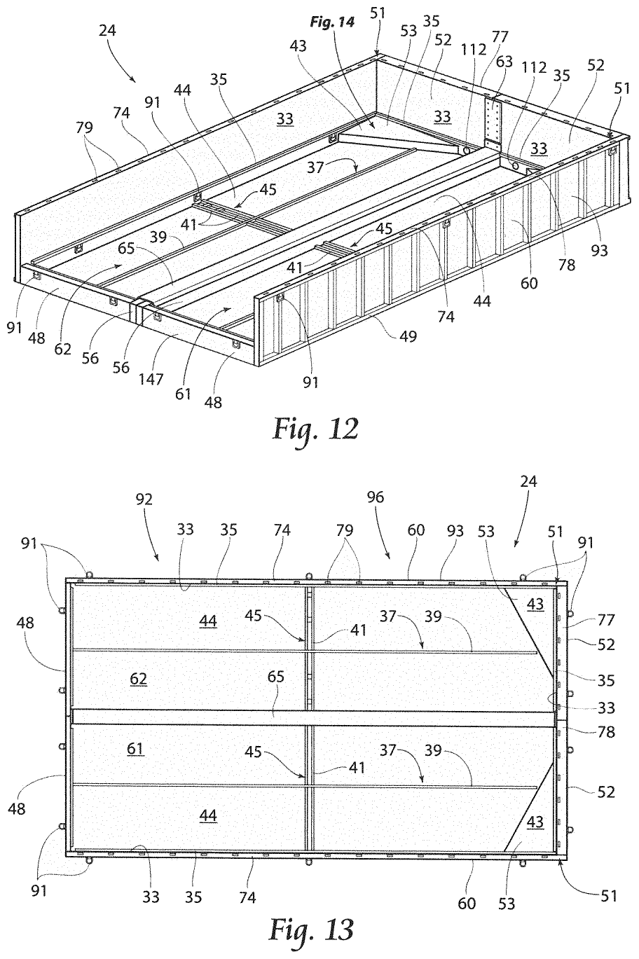

As illustrated in FIGS. 5 and 7, at a coupling rear end 55 of the second coupling member 65 provides for a rear wall extension 57 extending orthogonal, or at least substantial orthogonal, to the base 66 and opposite the flanges 67. The rear wall extension 57 it fastened to the rear walls 52 of the first and second basins (36, 40) as shown in FIG. 12. The rear wall extension 57 is positioned along the rear walls 52 of the first and second basins (36, 40) such that the rear wall extension 57 abuts, or alternatively is in close proximity to, the first coupling member 63 when the first coupling member 63 is positioned on the rear walls 52 of the first and second basins (36, 40). The rear wall extension 57 not only works with the first coupling member 63 to secure the first and second basins (36, 40) together, but the rear wall extension 57 works with the first coupling member 63 to cover or block a gap that may be present between the rear walls 52 of the first and second basins (36, 40), thereby inhibiting liquid that may be dumped onto the dump basin 24 from flowing through the gap and off of the dump basin 24. The rear wall extension 57 provides a covers or blocks a gap between the interior walls 56 and the rear walls 52, inhibiting liquid that may be dumped on the dump basin from flowing off the dump basin 24.

In one example, the second coupling members 65 merely rest upon the interior walls 56 of the first and second basins (36, 40). In other examples, the second coupling members 65 may be temporarily, permanently, or semi-permanently secured to the first and second basins (36, 40) in any manner (e.g., fastening, adhering, welding, bonding, etc.).

With particular reference to FIGS. 3, 4, 7, 12 and 15, the rear walls 52 and the exterior walls 60 of the first and second basins (36, 40) are substantially taller than the front walls 48 and the interior walls 56. With this configuration, the dump basin 24 provides a floor 64 elevated above bases 44 of the first and second basins (36, 40), three closed-off sides (i.e., the rear wall 52 and two exterior walls 60 extending above the floor 64), and one open side (i.e., the front wall 48 being substantially shorter than the other three walls). When the first and second basins (36, 40) are combined to create the dump basin 24, the front walls 48 of each basin (36, 40) combine to provide for a front side 147 of the dump basin 24, reference FIG. 12. The open side of the dump basin 24 allows an earthmoving implement 32 to drive onto the basin 24 and dump the solid/liquid mixture 119, reference FIGS. 1 and 22. The three closed-oft sides inhibit liquid from running or splashing off the floor 64 of the basin 24. In other words, the rear and exterior walls 52, 60 direct any liquid contacting the walls away from the walls and back onto the floor 64 of the dump basin 24.

In one example, a removable front splash shield may be coupled to the dump basin 24 adjacent the front walls 48 of the first and second basins (36, 40) to inhibit liquid from running or splashing off the front of the floor 64. In such an example, the front splash shield would be installed after the earthmoving implement 32 has driven onto the floor 64 and be removed prior to the earthmoving implement 32 driving off of the floor 64. The front splash shield may have any width and any height. In one example, the front splash shield may be about 8 inches in height and extends substantially the entire distance across the front of the dump basin 24.

Referring now to FIGS. 1-3, and 7, the system 20 includes one example of ramps 68 allowing the earthmoving implement 32 to elevate from a ground surface up, onto the floor 64 of the dump basin 24. Any type of apparatus may be used to elevate the earthmoving implement 32 onto the floor 64 of the dump basin 24. In another example, a hole may be dug into the ground surface and the dump basin 24 may be placed in the ground surface such that the floor 64 of the dump basin 24 is level with the ground surface. In such, an example, ramps or other apparatuses are not required to elevate the earthmoving implement 32 onto the floor 64. In a further example, the ground can be moved to be level with the top of the front wall 48 of the dump basin 24, thereby allowing an earthmoving implement 32 to drive onto the floor 64 of the dump basin 24. In such an example, ramps or other apparatuses are not required to elevate the earthmoving implement 32 onto the floor 64.

With reference to FIGS. 1 and 7, a removable platform 66 may be positioned between the dump basin 24 and the ramps 68, where the removable platform 86 contacts, or is in close proximity to, the front walls 43 of the basins (36, 40). The ramps 68 are in releasable contact, or substantially close to, the removable platform 86, opposite the front walls 48 of the basins (36, 40). The removable platform 86 structurally allows for a truck 23 to drive onto the platform from the ramps and onto the floors 64 of the dump basin 24.

With reference to FIGS. 2 and 7, in one example, the floor 64 is comprised or a plurality of floor port ions. In another example, the floor 64 may be a single, unitary member. In the illustrated example, the floor 64 is comprised of four floor portions 64a-64d.

With specific reference to FIGS. 3, S and 11, each floor portion comprises a flat, or substantially flat, plane 23. The floor comprises a top surface 25 and a lower surface 27 defined by floor perimeter 29. As illustrated in FIG. 11, the top surface 25, and lower surface 27 are separated by a floor thickness 31. As further illustrated in FIG. 11, in close proximity to the perimeter 23, the top surface 25 bevels towards the lower surface 27, a contacts the lower surface 27 along the perimeter 25.

As illustrated in FIG. 7, the floor 64 of the dump basin 24 defines a plurality of apertures 72 therein allowing liquid and small solid and finer solids (122, 124) to pass through the floor 64 and into the first and second cavities 61, 62 of the first and second basins (36, 40), 125, reference FIG. 23. The apertures 72 may have a wide variety of sizes, shapes, and configurations defined in the floor 64 and all of which are intended to be within the spirit and scope of the present disclosure. The apertures 72 may have a size, shape, and be configured based on the application in which the dump basin 24 will be used and the type of solid/liquid mixture to separate. In one example, the apertures 72 may all be the same size and shape. In ether examples, the apertures 72 may vary in size and/or shape in different areas on the floor 64.

In one example, the apertures 72 may be about 0.25 inches wide and about 3 inches long. In other examples, the apertures 72 may be between about 0.1875 inches and about 2 inches wide and between about 1 inch and about 6 inches long.

The apertures 72 may be formed in the floor 64 in a variety of manners. In one example, the apertures 72 may be plasma cut into the floor 64. The floor 64 can have a variety of thickness and be made of a variety of materials, in one example, floor 64 is made of steel and is about 0.25 inches thick. In such an example, the apertures 72 may be plasma cut into the steel floor 64.

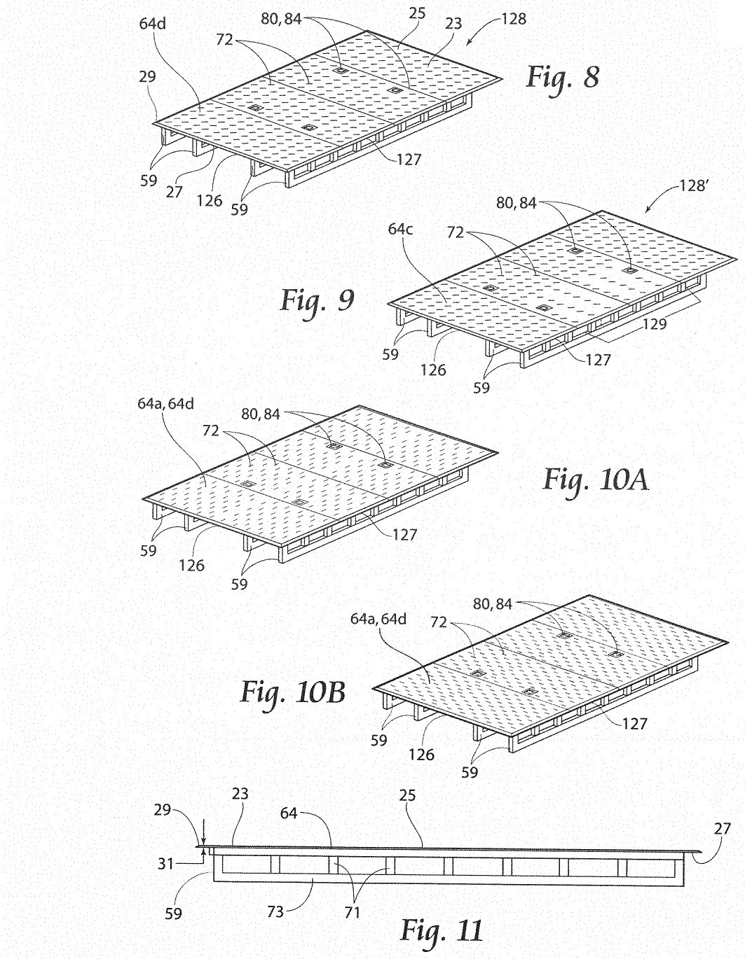

With particular reference to FIGS. 8-10B, the apertures 72 have a consistently spaced orientation relative to each other. As illustrated in FIG. 8, the apertures 72 for floor 64d are generally angled acutely from the direction of the floor front 126 in the direction of the floor inner side 127, which contacts the second coupling member 65 when the floor is in position within the dump basin 24, reference FIG. 7. The apertures 72 are angled acutely with respect to the front side 147, reference FIG. 7. Specifically, the apertures are arranged at a 45 degree angle. The apertures 72 are also arranged over substantially the entire floor 64d, and provide for a first embodiment of the aperture arrangement 128. As illustrated in FIG. 9, the same orientation of the apertures 72 applies to the apertures 72 within floor 64c. The apertures 72 within floor 64c are generally arranged over the entire floor 64c, with the exception of a central region 129 in close proximity to the floor inner side 127. The central region 129 provides for a reduced concentration of apertures 72. The reduced concentration of apertures 72 reduces the amount of solids (121, 122, 124) from passing through apertures 72 that may be immediately under the location where the solid/liquid mixture 119 is dumped. FIG. 9 illustrates a second embodiment of the aperture arrangement 128′. FIGS. 8 and 9 represent floors 64c and 64d which are positioned in the second basin 40, reference FIG. 7. As illustrated in FIG. 7, floors 64a and 64b are positioned in the first basin 36. The apertures of floor 64a are oriented from the floor front 126 in the direction of the floor inner side 127, and thus oriented opposite that of the apertures 72 of floor 64d. The apertures 72 of floor 64a are also arranged over substantially the entire floor 64a, and provide for the first embodiment, of the aperture arrangement 128. When in position in the dump basin the apertures 72 of floors 64a and 64d provide for a chevron shape in the direction of the rear walls 52, reference FIG. 2. The apertures of floor 64b are oriented from the floor front 126 in the direction of the floor inner side 127, and thus oriented opposite that of the apertures 72 of floor 64c. The arrangement of the apertures of floor 64c provides for the second embodiment of the aperture arrangement 128′ with the central region 129 in close proximity to the floor inner side 127 of floor 64c. When in position in the dump basin the apertures 72 of floors 64b anti 64c provide for a chevron shape in the direction of the rear walls 52, reference FIG. 2.

It should be understood the above is only one of many possible orientations and ail possible orientations of apertures 72 are within the spirit and scope of the present disclosure. For example, as illustrated in FIG. 10A, the apertures 72 of a floor (64a, 64b, 64c, 64d) may be oriented in a substantially linear pattern which is substantially parallel to the floor inner side 127. This orientation is orthogonal to the front side 147, reference FIG. 7 for orientation the apertures 72 with respect to the front walls 43 which comprise the front side 147. Further, as illustrated in FIG. 108, the apertures 72 of a floor (64a, 64b, 64c, 64d) may be orientated in a substantially linear pattern which is substantially orthogonal to the floor inner side 127. This orientation is parallel to the front side 147, reference FIG. 7 for orientation the apertures 72 with respect to the front walls 46 which comprise the front side 147. Further, the apertures 72 may be randomly arranged in the floor 64. In another example, the apertures 72 may be defined in some portions of the floor 64 and not present in other portions of the floor 64.

It is understood that features of the first embodiment of the aperture arrangement 128 may be combined with features of the second embodiment of the aperture arrangement 128′. It understood that features of the orientation of the apertures 72 as illustrated in FIGS. 8 and 9 may be combined with features of the orientation of the apertures as illustrated in FIG. 10A. It is understood that features of the orientation of the apertures 72 as illustrated in FIGS. 8 and 9 may be combined with features of the orientation of the apertures as illustrated in FIG. 102. It is understood that features of the orientation of the apertures 72 as illustrated in FIG. 10A may be combined with features of the orientation of the apertures as illustrated in FIG. 10B.

With reference to FIGS. 7, 12, 13, and 15, an internal surface 33 of both the sidewall 60 and the rear wall 52 of each of the first basin 36 and the second basin 40 provides for a floor support 35. As illustrated in FIGS. 6 and 7, the floor 64, preferably in close proximity to the perimeter 29 contacts the floor support 35 where the perimeter 29 of the particular floor (64a, 64b, 64c, 64d) is in close proximity to one of the sidewall 60 and the rear wall 52 of each of the first basin 36 and the second basin 40. The contact between the floor 64 and the floor support 35 is removable, allowing for the floor 64 to be lifted from the floor support 35. The contact between the floor support 35 is a loading bearing support allowing for a truck 32 to drive onto the floor 64 a deposit a solid/liquid mixture in the dump basin 24.

As illustrated in FIG. 5, the floor 64, preferably in close proximity to the perimeter 29 contacts the second coupling member 65, which covers the interior walls of the first basin 36 and the second basin 40, where the perimeter 29 of the particular floor (64a, 64b, 64c, 64d) is positioned against the second coupling member 65. The contact between the floor 64 and the second couple member 65 is removable, allowing for the floor 64 to be lifted from the second coupling member 65. The combination of the interior walls and the second coupling member 65 provides for a loading bearing support allowing for a truck 32 to drive onto the floor 64 a deposit a solid/liquid mixture in the dump basin 24.

With reference to FIGS. 8-11, the lower surface 27 of each floor (64a, 64b, 64c and 64d) extends at least one, put preferably four structural trusses 59. As illustrated in FIG. 11, the structural trusses 59 comprise truss legs 71 extending from lower surface 27. Opposite the lower surface 27 a footing extension 73 is attached to each truss leg 7i creating a support footing for each truss 59. The footing extension 73 comprises a footing surface 75 opposite the legs 71. As illustrated in FIG. 7, when a floor (64a, 64b, 64c, 64d) is place in position, in contact with the floor supports 35 and second coupling member 65, the footing surface 75 of each truss 59 contacts the base 44. Thus, the trusses 59 provide further structural support to the floor 64 allowing a truck 23 to drive onto the floor 64 and dump a solid/liquid mixture 115 on the floor 64 and safely exit the dump basin 24.

In one example, the floor 64 may be unitarily formed with the dump basin 24. In another example, the floor 64 may be removable from the dump basin 24. The illustrated example of the dump basin 24 includes a removable floor 64. Removability of the floor 64 may serve several purpose including, but not limited to, access to the first and second basins (36, 40) for cleaning and removing solids, access to the first and second basins (36, 40) for repairing or replacing damaged components, replacement of one or more floor portions 64a-64d if they become damaged, among others.

With continued reference to FIGS. 2, 3, and 5-7, each floor portion 64a-64d includes a plurality of lift mechanisms 60 to which a crane, lift, tractor, etc., may be coupled to lift each of the floor portions 64a-64d individually from the dump basin 24. In the illustrated example, each floor portion 64a-64d includes four lift mechanisms 80 to provide a 4-point connection. In other examples, each floor portion 64a-64d may include any number of lift mechanisms 80 (including zero). In the illustrated example, the lift mechanisms 80 are pivotal rings coupled to each of the floor portions 64a-64d. Each ring 80 pivots between a storage position, in which the ring 80 is positioned in a recess 84 defined in the floor portion 64a-64d and does not protrude from the recess 84 (see FIGS. 2 and 7-10B), and an operative position, in which the ring 80 is rotated upward and at least a portion of the ring 80 protrudes from the recess 84 to allow a hook, rope, chain, etc., to engage and couple to the ring 80 for lifting. In the illustrated example, the four lift mechanisms 80 are symmetrically oriented on each of the floor port ions 64a-64d with respect to the overall weight of the floor portion 64a-64d such that the floor portion 64a-64o is balanced and remains substantially horizontal when lifted via all four lift mechanisms 80.

As indicated above, a hydro-evacuation earthmoving implement 32 is configured to drive onto the floor 64 of the dump basin 24. Thus, the dump basin 24 must be constructed to support the relatively large weight of the earthmoving implement 32 and its load. The dump basin 24 is made of appropriate metal and/or steel to enable it to support the weight of the earthmoving implement 32. Since the floor 64 has to span a wide distance and yet needs to be sufficiently workable to cut apertures 72 therein and remove the floor 64 for cleaning and/or repair, the dump basin 24 must have adequate structure to support the floor 64.

With reference to FIGS. 7, 12 and 13, the bases 44 of the first basin 36 and the second basin 40 comprise a base framework 37. The base framework 37 comprises two components, an axial member 35 and a transverse section 41. The axial member 39 is position centrally between the sidewall 60 and interior wall 56 of each of the first basin 36 and the second basin 40 from the front wall 48 to a position in close proximity to the rear wall 52. Specifically the axial member 39 is positioned from the front wall 48 of a particular basin (36, 40) to a beveled edge 43 of the same basin (36, 40). The axial, member 39 is parallel to, or alternatively substantially parallel to, at least one of the sidewall 60 and the interior wall 56 of the respective basin (36, 40). The transverse section 41 is positioned on the base 44 from the interior wall 56 of a particular basin (36, 40) to the internal surface 33 of the exterior side wall 60 of the same basin (36, 40). The transverse section 41 is positioned on the base 44 at a transverse section location 45 at least substantially half the distance between the front wall. 46 and the rear wall 52. The transverse section 41 is perpendicular to, or alternatively at least substantially perpendicular to, the axial member 39. The axial member 39 intersects the transverse section 41. The transverse section 41 preferably comprises parallel members, or substantially parallel members, intersected by the axial member 39. Alternatively, the transverse section 41 may comprise a single member intersected by the axial member 39. The axial member 39 and transverse section 41 rise above the base 44. The respective heights of the axial member 39 and transverse section 41 rise above the base 44 allows for movement of fluid and solids (121, 124) over the axial member 39 and transverse section 41 in the direction of the respective dram 112, 130 reference FIG. 24.

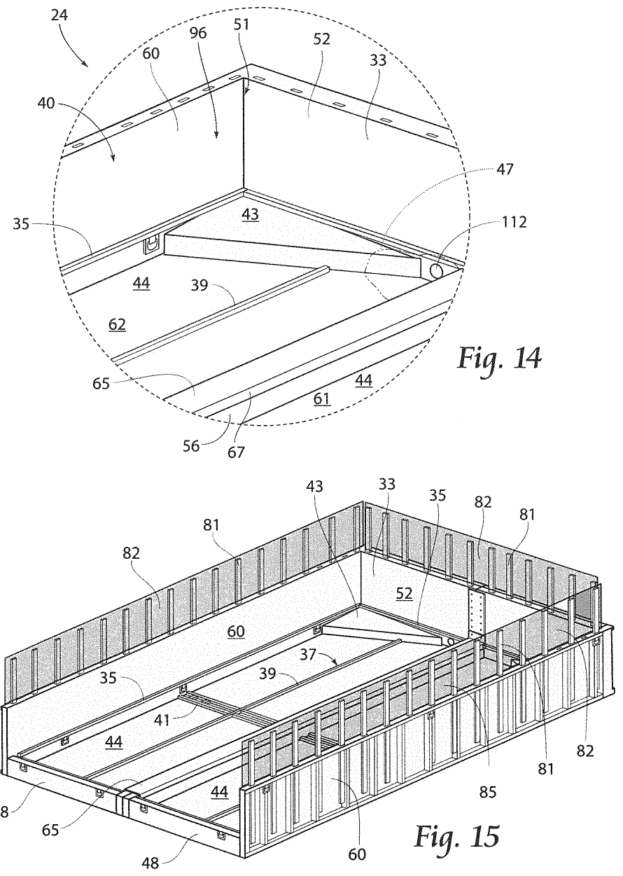

With further reference to FIGS. 7, 12 and 13, the beveled edge 43 is further described. A beveled edge 43 is positioned at a rear corner 51 of each basin (36, 40). The rear corner 51 is formed by the intersection of the sidewall 60 and the rear wall 52 of the respective basin (36, 40). The beveled edge 43 is fixed against the internal surface 33 of the sidewall 60, the internal surface 33 of the rear wall 52, and the rear corner 51. Specifically, the beveled edge 43 is fized against the internal surface 32 of the sidewall 60 below the floor support 35 along the sidewall 60. The beveled edge 43 is positioned below the floor support. 35 along the rear wall 52. Additionally, the beveled edge is positioned below the floor support 35 at the rear corner 51. The beveled edge 43 is affixed to each of the sidewall 60, rear wall 52 and rear corner 51 with a seemed connection. The beveled edge 43 preferably has a bevel top surface 53, reference FIG. 14. The beveled top surface 53 extends from the sidewall 60 and the rear wall 52 of the respective basin (36, 40) in the direction of the interior wall 56 of the respective basin (36, 40). The beveled edge 43 extends a predetermined distance from the sidewall 60 and a predetermined distance from the rear wall 52 and contacts the base 44 at a seemed connection. Further, the beveled top surface 53 provides for a pitch towards the base 44 from at least one of the sidewall 60 and the rear wall 52 towards the interior wall 56.

The pitch of the beveled top surface 53 provides for solids (122, 124) and liquids that fall thru the floor 64 onto the beveled top surface 53 to move towards the interior wall 56 and continue movement in the direction of the drain 112 of the respective basin (36, 40), 131 reference FIG. 24. The construction of the beveled edge 43 and mating of the Beveled edge to the sidewall 60, rear wall 52, rear corner 51 and the base 44 provides for a seemed transfer of fluid and solids from the beveled edge 43 to the base 44 and the respective dram 112. These beveled edges 43 also provide support to the respective basins (36, 40).

As illustrated in FIG. 14, a filtration material 47 may be removably positioned between the beveled edge 43 and the interior wall 56 of a respective basin (36, 40), in close proximity to, or in contact with the internal surface 33 of the rear wall 52. The filtration material 47 is positioned against the drain 112 of at least one of the respective basins (36, 40), below the floor 64. The filtration material 47 provides for additional separation of the solids and water before entering the tubes or pipes 140 and onto the filter container 28. The filtration material 47 may comprise at least one of a polymeric material, straw, hay, and fiber based material.

In one example, the dump basin 24 is configured to have a slight grade or pitch from the front walls 48 of the first and second basins (38, 40) to the rear walls 52 in order to ensure the liquid flows toward the rear walls 52 of the first and second basins (36, 40), 130, 131 reference FIG. 24. In another example, the dump basin 24 does not have a grade or pitch itself, but a ground surface may be prepared to have a grade or pitch, 130, 131 reference FIG. 24. The grade or pitch of the dump basin 24 or the ground surface may be any grade or pitch. In one example, the grade or pitch may be a minimum of about 4-degrees toward the rear of the dump basin 24.

With reference to FIG. 12, the exterior walls 60 each are defined by an exterior base side 49 and an opposite exterior topside 74, where the exterior base side 49 is pushed against the ground or a support surface. With reference to FIG. 4, the rear walls 62 are defined by a rear base side 76 and an opposite rear top side 77, where the rear base side 76 is pushed against the ground or a support surface. As illustrated in FIGS. 12 and 13, when the basins (36, 40) of the dump basin 24 are combined to create the dump basin 24, the exterior topside 74 of each basin (36, 40) and the rear top side 77 of each basin (36, 40) are combined to provide for the dump basin top side 78. The dump basin top side 78 comprises at least one top side through hole 79 along the dump basin top side 78. As illustrated in FIG. 13, a removable guard 85 is described. The removable guard 85 comprises at least one support member 81 and a barrier 82. The support members 81 may be positioned through the top side through holes 79. The support members 81 extend from the top side 78 opposite the ground, and opposite the basin 44, and opposite the floor supports 35. The barrier 82 is attached to the support members 81 along the dump basin top side 78. The barrier 82 extends from the top side 78 opposite the ground, and opposite the basin 44, and opposite the floor supports 35. The barrier 82 is preferably discontinuous. Alternatively, the barrier is continuous. The barrier 82 may be removably attached or fixed to the support members 81.

Referring now to FIGS. 1-4, 7, 12-13 and 15, each of the first basin 36 and the second basin 40 includes a plurality of second lift mechanisms 81 to which a crane, lift, tractor, etc., may be coupled to lift the first basin 36 and the second basin 40. These second lift mechanisms 91 are used when assembling or disassembling the dump basin 24 (described in more detail below). In the illustrated example, each basin (36, 40) includes seven second lift mechanisms 91 along the basin exterior 93 of the basin (36, 40). The exterior 93 is opposite the internal surface 33 further, each basin (36, 40) includes four lift mechanism 91 along the internal surface 33. In other examples, each basin (36, 40) may include any number of lift mechanisms (including zero). The lift mechanisms 91 may be at least one of pivotal rings and fixed flanges with an aperture in each flange. The rings 91 operate in a manner similar to the rings described with respect to the floor 64 and the fixed flanges 91 do not move and remain in the same configuration. The lift mechanisms 91 are symmetrically oriented on each of the basins (36, 40) with respect to the overall weight of the basins (36, 40) such that the basins (36, 40) are balanced when lifted via the lift mechanisms 91. Less than ail of the lift mechanisms 91 may be used to lift the basins (36, 40). In doing so, only four of the lift mechanisms 91 per basin (36, 40) may be required to lift each basin (36, 40). Alternatively, more than four lift mechanisms 91 may be used to lift the basin (36, 40). Alternatively, less than four lift mechanisms 91 may be used to lift the basin (36, 40).

Upon completion of one or more dumping processes onto the dump basin 24, u will be desirable or necessary to remove the solid debris on the top surface of the floor 64. As illustrated in FIG. 4, the rear wall 52 of each basin (36, 40) comprises at least one, preferably more than one, structural reinforcement member 94. Each member 94 extends from at least in close proximity to the exterior base side 49 along the base exterior 93 to at least in close proximity to the exterior top side 74. The members 94 reinforce each rear-wall 52. When the basins are combined to create the dump basin 24, the members 94 provide for reinforced rear walls 52 to assist with this removal process.

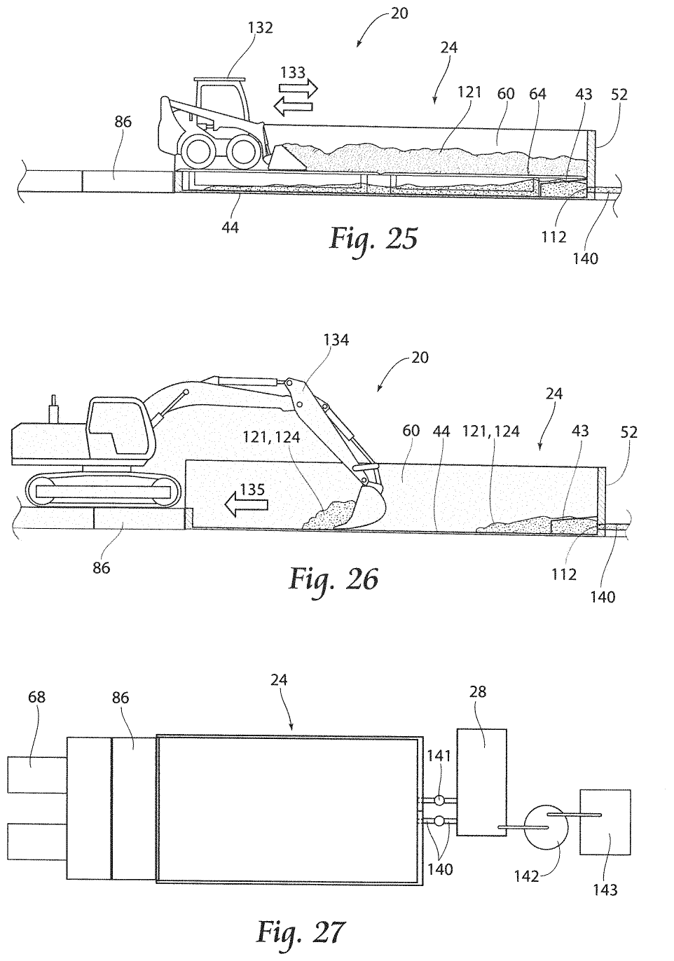

With reference to FIG. 25, in operation, a solid/liquid mixture 119 would be dumped onto the floor 64 of the dump basin 24 in front of the rear walls 52, FIG. 22. After an adequate amount of liquid and solids (122, 124) has drained through the floor 64 and only the larger solid material 121 remains on the floor 64, a skid loader with a bucket, front end loader, or other type of machine, 132 may be driven onto the floor 64 of the dump basin 24, move its bucket along the top surface of the floor 64 into the solid material remaining on the top surface of the floor 64, and against the rear walls 52, 133. The rear walls 52 assist with the solid material moving into the bucket rather than continuing to be pushed toward the rear of the dump basin 24. The skid loader then lifts its bucket with the solid debris 121 therein and moves rearward until the skid loader is free of the dump basin 24.

When a sufficient amount of smaller solids accumulates on the bases 44 of the first and second basins (36, 40), the floor 64 (or floor portions) may be removed to all cleaning of the first and second basins (36, 40). The solids 121, 124 may be cleaned from the first and second basins (36, 40) in a variety of manners. As illustrated in FIG. 26, with the floors 64 removed, an earthmoving equipment backhoe 134 is used to remove the debris, solids 121, 124, from bases 44 of the basins (36, 40), 135. In one example, one or mere individuals may manually scoop, shovel, etc., the debris from the basins (36, 40). In another example, a work earthmoving implement, such as a skid loader with a bucket, front end loader, or other type of machine, 132, may be used to scoop out the debris. In combination with these examples or in a separate example, the dump basin 24 may include one or more nozzles configured to spray liquid into the first and second basins (36, 40) in order to clean the debris from the basins (36, 40). The nozzles may be coupled to a variety of different types of liquid sources such as, for example, the liquid filtered by the filter container 26 (described in more detail below), a water truck, its own water source (e.g., city water source or well water source), among others.

Referring now to FIGS. 16-19, one example of a filter container 26 is illustrated. The filter container 29 is configured to further filter the solid/liquid mixture dumped onto the dump basin 24. As indicated above, the floor 64 filters a first amount and size of the solid 121 from the solid liquid mixture, but smaller solids 122, 124/sediment may pass through the apertures 72 in the floor 64. Further, with the smaller solids 122 settling on the base 44, the remaining solid 124/liquid mixture exits the drains 112 in the first and second basins (36, 40), passes through pipes or tubes 140 and into the filter container 28.

As illustrated in FIG. 27, a valve 141 is coupled to each of the tubes 140 and is configured to selectively affect flow of liquid through the tubes 140. The valves 141 may be manually operable and may be fully opened, fully closed, or any position between fully opened and fully closed. The valves 141 may be any type of valve and ail of such possibilities are intended to be within the spirit and scope of the present disclosure. In one example, the valves 141 may be camlock valves.

With particular reference to FIGS. 16 and 13, the filter container 28 includes four inlets 144, with two of the four inlets at a first height 87 from, a filter container base 90. The second two inlets 144 of the four inlets are at a second height 89 from the base 90, where the second height 89 is a greater distance from the base 90 than that of the first height 87. The inlets are positioned at two different heights in order to address pressure concerns caused when the fluid pressure in the filter container approaches the fluid pressure of the fluid in the tubes 140. For each pair of inlets, one inlet 144 for receiving the remaining solid/liquid mixture from each of the first and second basins (36, 40). The filter container 28 includes four deflectors 143 with one deflector 143 oriented above and partially in front of each inlet 144. When the solid/liquid mixture is dumped onto the dump basin 24, a rush of the remaining mixture will be forced through the dump basin 24, out of the drains 112, and into the filter container 28. The deflectors 143 are in the path of the rushing remaining solid/liquid mixture and create a resistance or turbulence to the rushing remaining solid/liquid mixture. This resistance or turbulence knocks-down or causes the remaining solid in the mixture to settle within the filter container 28.

The filter container 26 also includes a weir plate 152 to assist with removing the remaining solids from the liquid. As illustrated in FIG. 16, the filter container 23 includes at least one support 156 on each side of the filter container 28 for engaging and supporting ends of one or more weir plates 152 in the filter container 28. The filter container 23 includes a plurality of weir plates 152 in order to allow adjustment of the water level in the filter container 23. A seal may be coupled to one or both of the engaging edges of the weir plates 152 to assist with sealing between the plates in order to inhibit liquid from passing between the plates 152. A seal may also be positioned on a bottom edge of the bottom weir plate to seal against the bottom of the filter container 28. The seals may be any type of seal capable of inhibiting liquid from passing between the plates or between the plates and the filter container. For example, the seal may be a gasket, or other resilient member.

With reference to FIG. 17, an alternative embodiment of a wear plate 152′ is described. The weir plate 152′ comprises a screen or mesh 83. The screen or mesh 83 provides for further separation of solids (124, 137) and liquids. It is understood that features of weir plate 152 may be combined with features of weir plate 152′.

In operation, the remaining solid/liquid mixture flows into a first side 160 of the filter container 28 including the inlets 144 (sides of the container, in this example, are defined by the location of the one or more weir plates). Due to gravity, the small solids or sediment settles to the bottom of the filter container 28 on the first side 160 as the liquid rises. The deflectors 143 also inhibit the rushing water from stirring-up or mixing-up the already settled sediment on the first side 160. As the liquid rises to the top of the weir plate(s) 152, substantially only liquid washes over the weir plate(s) 152 to a second side 164 of the filter container 26 since most of the sediment is settled/trapped on the first side 160 of the filter container 28. The filtered liquid may then be pumped from the filter container 28 with a pump 136. When the sediment accumulates to a certain degree in the filter container 26, the liquid can be pumped from the filter container 28 and the sediment can be removed. Once the sediment is removed, the filter container 28 can be used again as described above.

With reference to FIG. 19, another example of a filter container 28′ is illustrated. Components of the filter container 28′ illustrated in FIG. 19 similar to components of the filter container 28 in FIGS. 16 and 18 will have the same reference numbers. In this example, the filter container 23′ is configured to filter both finer solids 124 and floaters 137 on the surface of the liquid. Many types of objects, liquids, substances, etc., may have greater buoyancy than the main liquid in the system 20. Examples of such floaters 137 include, but are not limited to oils, plastics, etc. The filter container 23′ includes a second weir 163 to assist with removing floaters 137 from a surface of the liquid. In the illustrated example, the filter container 28′ includes one support 156 on each side of the filter container 23′ for engaging and supporting ends of one or more second weir plates 168 in the filter container 28′. The filter container 28′ also includes a stop 176 at a bottom of each support 172 to limit the downward travel of the one or more second weir plates 163 and provide a gap 180 underneath the one or more second weir plates 168 and the bottom of the filter container 28′. In the illustrated example, a top 134 of the first weir 133 is vertically higher than a bottom edge 186 of the second weir 168

In operation, a water level W is maintained in the filter container 26′ and such water level W is above both the top edge 184 of the first weir 138 and the bottom edge 186 of the second weir 163. The remaining solid 124/liquid mixture flows into a first portion 194 of the filter container 28′ defined between the first weir 133 and an end wall of the filter container 28′ near the inlets 144. Due to gravity, the small solids or sediment settles 124 to the bottom of the filter container 26′ in the first portion 184 and floaters 137 rise to the surface of the water W (or may be suspended in the liquid above the bottom edge 188 of the second weir 168. The deflectors 148 also inhibit the rushing water from stirring-up or mixing-up the already settled sediment in the first portion 194.

The water level W is maintained throughout the filter container 23′ and thus the water surface/level W extends throughout the first portion 194, a second portion 193 defined between the first weir 138 and the second weir 168, and a third portion 202 between the second weir 169 and an end wall of the filter container 28′ opposite the other end wall and inlets 144. The rising floaters 137 moves to the surface of the liquid W in both the first and second portions 194, 198 of the filter container 28′. The thickness of the floaters 137 is typically minimal when compared to the depth of the liquid. Thus, the floaters 137 on the surface of the liquid W remains well above the bottom edge 188 of the second weir 168. Only liquid is in the filter container 23′ below the bottom edge 188 of the second weir 163. Thus, only liquid passes under the bottom edge 188 of the second weir 163 into the third portion 202 of the filter container 28′. The filtered liquid can then be removed from the third portion 202 of the filter container 28′. It is understood that features of filter container 28 may be combined with features of filter container 28′.

As illustrated in FIGS. 22-26, upon completion of the dumping process, larger solids 124 remain on the floor 64 of the dump basin 24, smaller solids 121 on the basin floor 44, and finer solids 121 or sediment remain in the filter container 28, and liquid remains in the filter container 28. The larger solids 124 and smaller solids 121 may be dumped in most landfills since they have been dewatered. The system 20 prepares the larger solids to pass the “paint filter test” or solid stability test. Alternatively, the larger solids may be recycled in a variety of manners. The liquid in the filter tank, may be disposed of or may be reintroduced into the earthmoving implement 32 for future hydro-excavation. As illustrated in FIG. 27, in some examples, the liquid may be run through one or more further filtering processes prior to reuse. For example, the liquid may be pumped through a dual bag filter system 142. In other examples, the liquid and/or sediment may be pumped to a Frac tank (e.g., a 10,000 gallon Frac tank) 143 to remove suspended solids or contaminants for future disposal, reuse, or re-cycling. In further examples, the liquid may be reused directly from the filter container 28.

The system 70 of the present disclosure is easily transportable via truck (e.g., 18-wheeler flatbed truck) over standard roads and highways, which makes it easy to install the system 20 at any desirable location and to move the system 20 if necessary. The system 20 may be located at a variety of locations including, but not limited to, landfills or any worksite where solid/liquid mixtures are being created. Locating the system 20 at a landfill provides an alternative to dumping solid/liquid mixtures at the landfill. For landfills charging extra fees for solid/liquid mixtures, this extra fee can be avoided by dumping the solid/liquid mixture onto the system 20. Then the solid can be dumped at the landfill and the liquid can be reused, recycled, transported to another location, etc.

Additionally, as mentioned above, some landfills prohibit dumping of solid/liquid mixtures. Locating the system 20 at these landfills prohibiting solid/liquid mixtures will provide an earthmoving implement 32 with the opportunity to dump the solid/liquid mixture at these landfills. More particularly, the earthmoving implement 32 may dump the solid/liquid mixture onto the system 20, separate the solids from the liquid, and dump the solids at the landfill. Furthermore, the ability to transport the system 20 allows the systems 20 to be installed at worksites where solid/liquid mixtures are being created. For example, with respect to hydro-excavation, a hydro-excavation earthmoving implement 32 may be excavating, thereby creating solid/liquid mixtures. Once the earthmoving implement 32 is finished excavating, the earthmoving implement 32 only needs to travel, a short distance to the onsite system 20 and dump its solid/liquid mixture onto the system 20. The liquid may be reintroduced into the earthmoving implement 32 for further excavating and the solids may be disposed of onsite or at a nearby location. The onsite system 20 decreases earthmoving implement 32 travel time to and from landfills or ether dump sites, thereby increasing the operating time and efficiency of the earthmoving implement 32 and the crew operating the earthmoving implement 32. This provides significant cost savings.

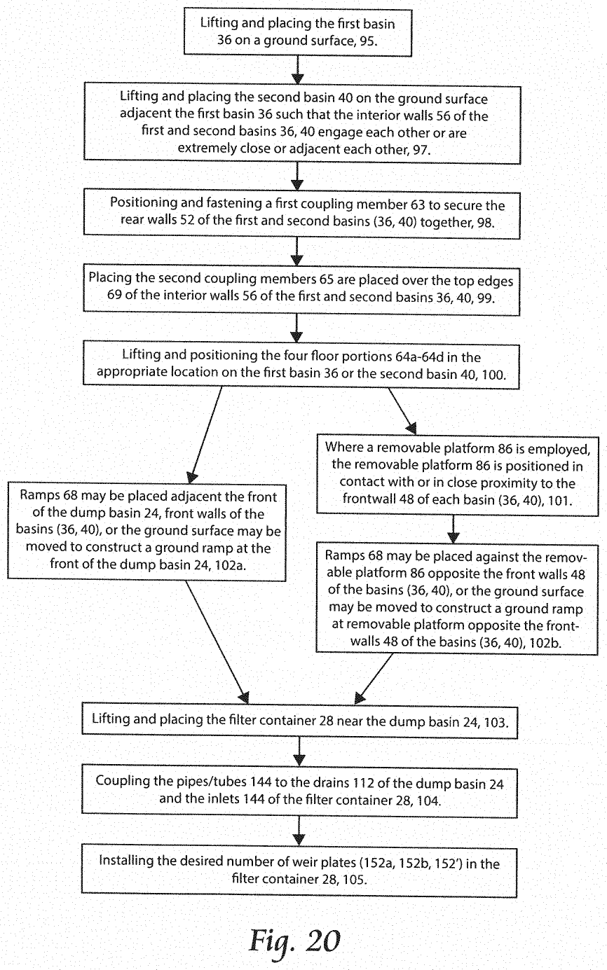

With reference to FIG. 20, the system 20 may be easily assembled and disassembled in order to facilitate transportation of the system 20. In the disassembled condition, the system 20 will fit on a flatbed of an 18-wheeler truck. It should be understood that the system 20 may be assembled and disassembled in a variety of manners and the steps of assembly and disassembly may occur in different orders. The following example of assembly is only one of many examples of assembly and is not intended to be limiting.

To begin assembly of the system 20, the first basin 36 is lifted by a lift via the lift mechanisms 91 and placed on a ground surface, 95. The lift then lifts the second basin 40 via the lift mechanisms 91 and places the second basin 40 on the ground surface adjacent the first basin 36 such that the interior walls 56 of the first and second basins (36, 40) engage each other or are extremely close or adjacent each other, 97. The ground surface may be pitched or angled placing the first and second basins (36, 40) on an incline, or the first and second basins (36, 40) may be configured to have a pitch to facilitate gravity feed of the liquid toward the drains 112.

With the first and second basins (36, 40) in this position on the ground surface, the first coupling member 63 and the second coupling members 65 may be used to couple the first and second basins (36, 40) together. The first coupling member 63 is properly positioned and the numerous fasteners are tightened to secure the rear walls 52 of the first and second basins (36, 40) together, 38. The second coupling members 65 are placed over the top edges 69 of the interior walls 56 of the first and second basins (36, 40), 99. The floor 64 of the system 20 may tow be installed. The four floor portions 64a-64d may be installed in any order. The lift lifts each of the four floor portions 64a-64d via their lift, mechanisms 80 and places them in the appropriate location on the first basin 36 or the second basin 40, 100. Where a removable platform 86 is employed, the removable platform 86 is positioned in contact with or in close proximity to the front wall 48 of each basin (36, 40), 101. Ramps 68 may be placed adjacent the front of the dump basin 24, front walls of the basins (36, 40), or against the removable platform 86 opposite the front walls 48 of the basins (36, 40), or the ground surface may be moved to construct a around ramp at the front of the dump basin 24 or against the removable platform 86 opposite the front walls 43 of the basins (36, 40), (102a, 102b).

The filter container 23 may be lifted and placed near the dump basin 24, 103. In some examples, it may be preferred to locate the filter container 28 near the rear walls of the dump basin 24 to decrease the length of tubes/pipes 140 required to couple the drains 112 of the dump basin 24 and the inlets 144 of the filter container 28. Once the filter container 28 is positioned, the pipes 144 are coupled to the drams 112 of the dump basin 24 and the inlets 144 of the filter container 23, 104. The desired number of weir plates (152a, 152b, 152′) may be installed in the filter container 28, 105. At this point, the system 20 is ready to receive an earthmoving implement 32 for dumping solid/liquid mixture.

In some examples, a front plate or shield may be installed at the front of the dump basin 24 near the front walls 48 of the first and second basins (36, 40) to act as a front splash guard. The front plate would need to be installed after the earthmoving implement 32 backs onto the floor 64 of the dump basin 24 and removed prior to the earthmoving implement 32 driving off of the dump basin 24. In other examples, a ramp may be installed near the front of the dump basin 24 near the front walls 48 of the first, and second basins (36, 40) to act as a front splash guard. In this example, the ramp may be ramped on one or both sides such that an earthmoving implement (32, 132) may back over the ramp when driving onto the floor 64 and drive over the ramp when driving off of the floor 64. Additionally, the ramp is sufficiently high to inhibit liquid from running off the front of the dump basin 24. Furthermore, in this example, the ramp would not need to be removed prior to the earthmoving implement. (32, 132) driving onto or off of the floor 64. In further examples, a slot or aperture may extend across a substantial portion of the floor 64 near the front of the dump basin 24. In this example, the slot or aperture may be significantly longer and wider than any of the apertures 72 defined in the floor 64. Liquid flowing across the floor 64 toward the front of the dump basin 24 would fail into the larger slot, or aperture and into one of the first or second basins (36, 40).

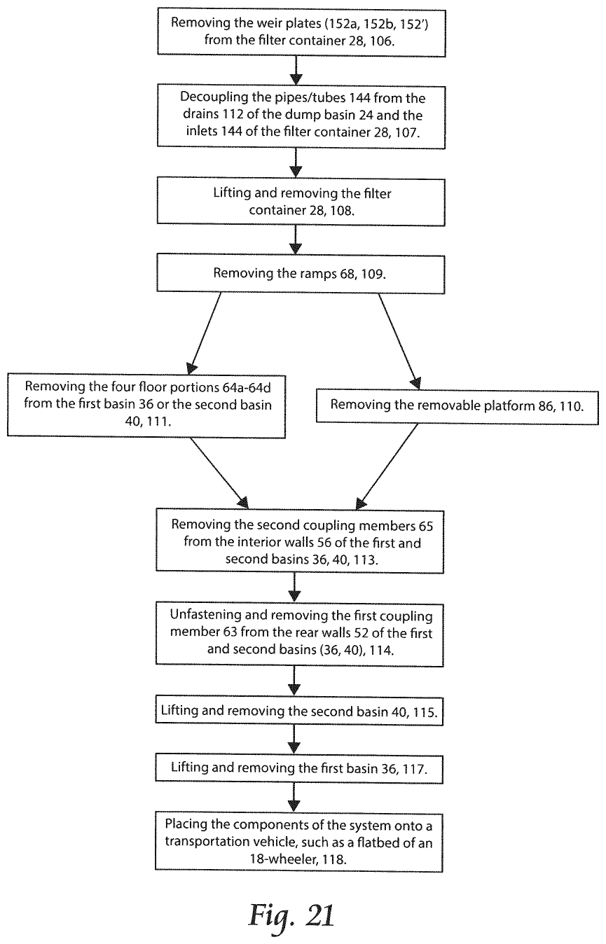

With reference to FIG. 21, to disassemble the system 20, the assembly steps may be performed IP reverse order and the components of the system 20 may be stacked onto a transportation vehicle, such as a flatbed of an IS-wheeler (106 to 111, 113 to 115, 117, 118).

It should be understood that the use of any orientation or directional terms herein such as, for example, “top”, “bottom”, “front”, “rear”, “back”, “left”, “right”, “side”, etc., is not intended to imply only a single orientation of the item with which it is associated or to limit the present disclosure in any manner. The use of such orientation or directional terms is intended to assist with the understanding of principles disclosed herein and to correspond to the exemplary orientation illustrated in the drawings. For example, the system 20 may be utilized in any orientation and use of such terms is intended to correspond to the exemplary orientation of the system 20 illustrated in the drawings. The use of these terms in association with the system 20 is not intended to limit, the system 20 to a single orientation or to limit the system 20 in any manner.

It should also be understood that use of numerical, terms such as, for example, “first”, “second”, “third”, etc., should not be interpreted to imply an order or sequence of components or functions. Moreover, use of these numerical terms is not intended to pertain to only the component and/or function with which they are utilised. Rather, the use of these numerical terms are merely used to assist the reader with understanding the subject matter of the present disclosure. For example, one of the components in the specification may be referenced as a “first component”, but the same component may be referenced differently in the claims (e.g., second or third component).

The Abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than ail features of a single disclosed embodiment. Thus, the following claims are hereby incorporated into the Detailed Description, with each claim standing on its own as a separately claimed subject matter.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A system for dewatering a solid/liquid mixture, the system comprising:
a dump basin defined by a plurality of walls and having a front side, wherein an earthmoving implement drives through said front side into said dump basin;
said dump basin defining a cavity;
said dump basin including a floor over said cavity;
said floor comprising at least one structural truss extending into said cavity; and
said floor having at least one aperture formed therein; wherein a portion of said solid/liquid mixture is filtered through said at least one aperture.

2. The system of claim 1, wherein said dump basin comprises a first basin removably coupled to a second basin along interior walls of said dump basin.

3. The system of claim 1, further comprising at least one earthmoving implement entry ramp in close proximity to said front side.

4. The system of claim 1, further comprising a plurality of apertures formed in said floor.

5. The system of claim 4, where in said floor has a predetermined area with a reduced number of apertures for receiving said solid/liquid mixture.

6. The system of claim 1, wherein said at least one aperture is positioned at an acute angle with respect to said front side.

7. The system of claim 6, wherein said at least one aperture is positioned opposite a second aperture providing for a chevron pattern.

8. The system of claim 1, wherein said at least one aperture is positioned at least one of parallel to said front side and orthogonal to said front side.

9. The system of claim 1, wherein said floor comprises four floor sections.

10. The system of claim 9, wherein at least one floor section has at least, one structural truss extending from said floor section into said cavity, said structural truss affixed to a first side of said at least one floor section.

11. The system of claim 1, further comprising said floor detachably positioned within said dump basin.

12. The system of claim 11, wherein said floor comprises at least one first lift mechanism for detachable positioning of said floor relative to said dump basin.

13. The system of claim 1, further comprising said cavity having at least one drain formed opposite said front side, wherein a portion of said solid/liquid mixture flows toward said drain.

14. The system of claim 13, further comprising a filter container hydraulically coupled with said at least one drain, wherein a portion of said solid/liquid mixture is further filtered in said filter container.

15. The system of claim 13, further comprising a beveled edge; within said cavity, wherein a portion of said solid/liquid mixture is advanced toward said drain.

16. The system of claim 1, further comprising at least one barrier removably positioned on at least one wall.

17. A method of operating a system for dewatering a solid/liquid mixture, the method comprising:
depositing a solid/liquid mixture onto a floor of a dump basin;
filtering a portion of said solid/liquid mixture through apertures in said floor into a cavity of said dump basin;
directing an amount of said solid/liquid mixture in a direction of at least one drain;
channeling said amount of said solid/liquid mixture from said drain to a filter container;
removing solids remaining on said floor using an earthmoving implement; and
removing said solids within said cavity through use of at least one of a mechanical arm and aid earthmoving implement positioned into said cavity.

18. The method of claim 17, further comprising driving an earthmoving implement onto said floor for removing said solids from said floor.

19. The method of claim 17, further comprising utilizing a rear side of said dump basin as a backstop to remove said solids from said floor.

20. A method of assembling a system for dewatering a solid/liquid mixture, the method comprising:
positioning a first basin;
positioning a second basin in contact with said first basin along parallel interior walls of said first basin and said second basin;
coupling said first basin to said second basin along said interior walls;
positioning at least one floor section within at least one of said first basin and said second basin;
hydraulically coupling at least one of said first basin and said second basin to a filter container; and
installing at least one filter assembly into said filter container.
